(19) United States
(12) Patent Application Publication
(10) Pub. No.: US 2006/0055797 A1
(43) Pub. Date: Mar. 16, 2006

(54) Interactive message apparatus

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/938,631

(22) Filed: Sep. 13, 2004

(51) Int. Cl. H04N 5/76

(52) U.S. Cl. 348/231.4

(57) ABSTRACT

An interactive message apparatus is disclosed. The interactive message apparatus can be mounted on the front gate or the room gate to record and show the dynamic audio-visual message. A control unit for processing and controlling image and voice is mounted on the main body of the present invention, wherein the control unit is a signal processing control center. Several record/display buttons are mounted on the main body to record various messages, wherein several corresponding indicator lights for reminding and notifying that there is a message are mounted on the main body. A timer is connected to the control unit to show a predetermined message at the predetermined time. A sensor is mounted on the main body to transmit a sensor signal to the control unit so as to show the predetermined message. A photographic device can be applied to take a note down for monitoring. Thus, the reminding and care sharing effects are accomplished so as to act an interactive communication medium for family members.

### BACKGROUND OF THE INVENTION

The present invention relates to an interactive message apparatus, and more particularly to an apparatus through which dynamic audio-visual messages can be pre-recorded and somebody can be suggested to take the messages.

Even through family members met with one other everyday, a family member usually cannot find somebody, when he wants to leave words to this person, or when he wants to say something that he cannot talk about face to face. Another communication way at this moment is to leave a message. A common method is to set up a message board. Thus, the content of the message can be written down on the message board or the notepaper that is thereafter pasted up on the message board. The current method of leaving message utilizes the written text, namely, it is a passive way. Thus, its interactive effects on reminding, warning, or encouraging somebody are poor. The present method of leaving message cannot automatically provide with various message contents at a predetermined date or time. With the progress of the digital image and voice, if the planar type of text message can be replaced with the dynamic type of audio-visual message and used to guide the family member to take the message, the better interactive consideration effect will be generated so as to act an excellent communication medium.

### SUMMARY OF THE INVENTION

The main purpose of the present invention is to provide an interactive message apparatus, in which an image and voice message can be pre-recorded and broadcasted, and a predetermined message can be shown at a predetermined date and time to achieve the effects of exhorting, reminding, care sharing, and interaction.

Another purpose of the present invention is to provide an interactive message apparatus. The family member can be guided to take the message through the indicator lights to achieve an interactive communication effect.

It is still another purpose of the present invention to provide an interactive message apparatus for taking notes down to verify the incoming and outgoing records of the family member through a photographic device.

According to the aforementioned purposes of the present invention, a control unit is mounted on a main body of the present invention for processing and controlling the recording and showing of image and voice. The present invention further comprises:

a voice input device connected to the control unit to input a voice signal for recording the voice;

a photographic device for capturing an image through a camera lens and processing the image signal;

a storage device for storing image and voice signal data connected to the control unit, wherein the storage device is a flash memory card or a hard disk;

a showing device for showing the recorded image and voice connected to the control unit, wherein the showing device comprises a monitor for showing the recorded image, and a speaker for showing the voice;

a timer for showing the predetermined recorded message at a predetermined time connected to the control unit;

a plurality of record/display buttons for recording various voice and image messages or taking the messages, wherein several indicator lights are mounted corresponding to these record/display buttons for notifying somebody that there is a message for him;

a sensor used for transmitting a sensor signal to the control unit so as to drive the showing device to show the content of the predetermined message, wherein the sensor is an optical switch, a magnetic control switch, or a micro switch, wherein the sensor can be mounted on the door side so as to show the message automatically upon opening the door.

The aforementioned aspects and advantages of the present invention will be readily clarified in the hereafter description of examples of preferred embodiments of the present invention, in reference with the enclosed drawings.

The present invention intends to cover all alternatives and arrangements of these alternatives. Nevertheless, the selected preferred embodiment is described in the specification and illustrated in the accompanying drawings.

### BRIEF DESCRIPTION OF THE DRAWINGS

FIG. 1 is a schematic diagram showing an outward-appearance of the present invention.

FIG. 2 is a composition block diagram of the present invention.

FIG. 3 is a schematic diagram showing the using status of mounting the present invention on the front gate.

### DETAILED DESCRIPTION OF THE PREFERRED EMBODIMENT

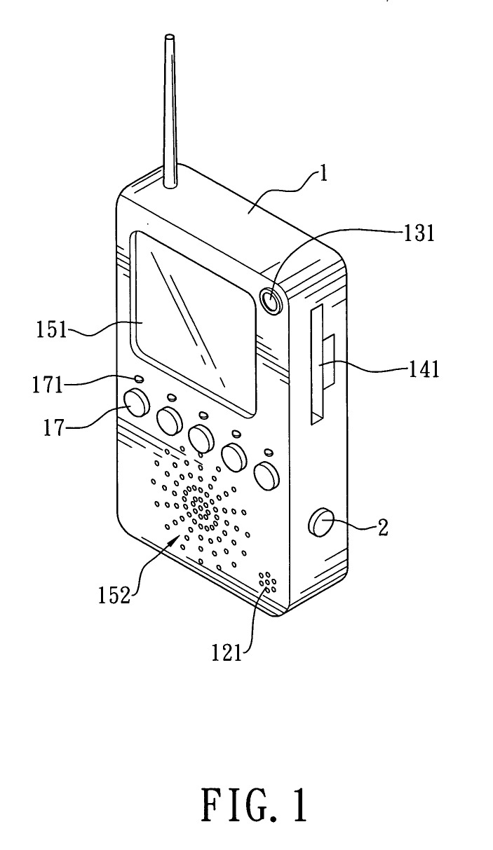

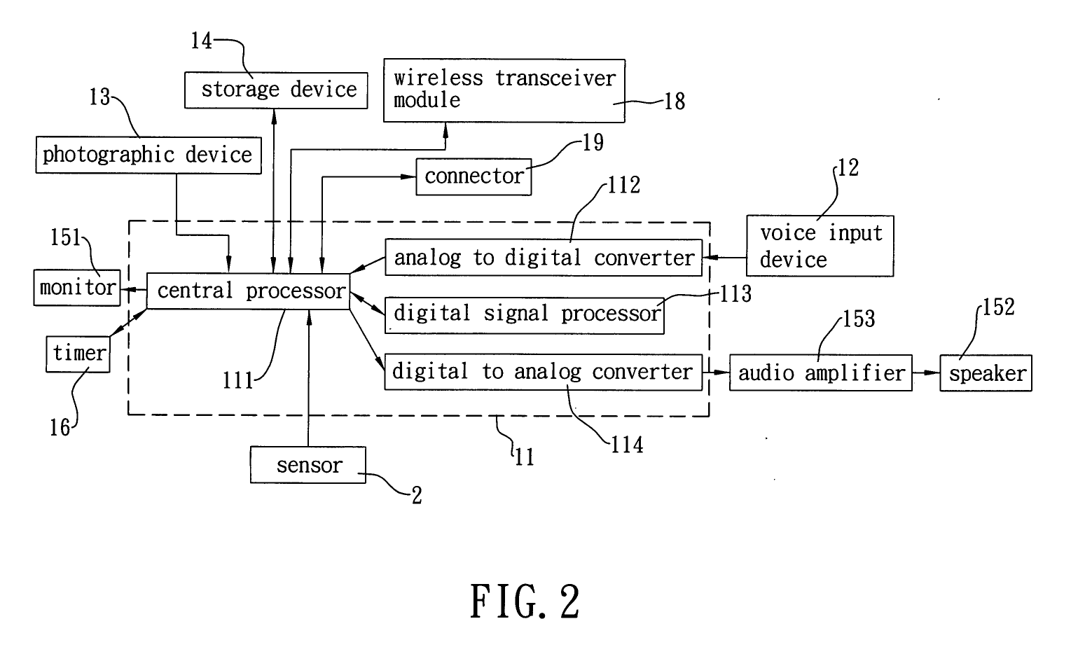

FIG. 1 is a schematic diagram showing an outward-appearance of the present invention. FIG. 2 is a composition block diagram of the present invention. As shown in FIG. 1 and FIG. 2, a main body 1 comprising the following devices is provided in the present invention.

A control unit 11 for processing and controlling the recording and showing of image and voice is acted as a processing control center of a signal, wherein the control unit 11 comprises a central processor 111 acted as a processing control center of the signal, an analog to digital converter 112 for converting the inputted image and voice signal into a digital signal and transmitting the digital signal to the central processor 111, a digital signal processor 113 connected to the central processor 111 for performing a digitizing treatment of the image and voice signal, and a digital to analog converter 114 for converting an outputted signal into an analog signal.

A voice input device 12 such as a microphone 121 for inputting the voice signal to record the voice is connected to the control unit 11.

A photographic device 13 is provided for capturing an image through a camera lens 131 and processing the image signal.

A storage device 14, for example, a flash memory card or a hard disk, for storing image and voice signal data is connected to the control unit 11.

A showing device 15 for showing the recorded image and voice is connected to the control unit 11, and comprises a monitor 151 for showing the recorded image, and a speaker 152 driven by an audio amplifier 153 for showing the voice.

A timer 16 for showing a predetermined recorded message at a predetermined time is connected to the control unit 11.

Several record/display buttons 17 for recording various voice and image messages or taking the messages, wherein several indicator lights 171 are mounted corresponding to these record/display buttons 17 for notifying the user that there is a message for him.

These record/display buttons 17 can be assigned to various persons, for example, a first buttons is assigned to father, a second button is assigned to mother, a third key is assigned to their child, and so forth. When a family member wants to leave a message to the child, the third button can be pressed down so as to input voice through the microphone to record a voice message. Accordingly, a corresponding indicator light 171 will be lighted to notify the child that there is a message for him. The reminding of indicator light 171 guides the child to take the message about reminding and care from his parent. Consequently, a predetermined person can be notified to take the message.

A wireless transceiver module 18 is connected to the control unit 1I1 for interacting with a computer or other compliant apparatus and for inputting or outputting the data so as to be applied to storing, modifying, and forwarding applications. The wireless transceiver module 18 is a bluetooth module, a wireless frequency modulation system, an infrared ray transmission, a Radio Frequency Identification Code (RFID) system, etc. The RFID system can identify the identities of staffs so as to execute some instructions such that incoming and outgoing of family members, purchased articles, or sold articles can be scanned for recording and monitoring thereof. Thus, these data can be accessed and applied for restraining daily shopping and materials, notifying users of overdue vegetables or articles, or the like.

A connector 19 such as a USB interface card is connected to an apparatus such as computer for transmitting data.

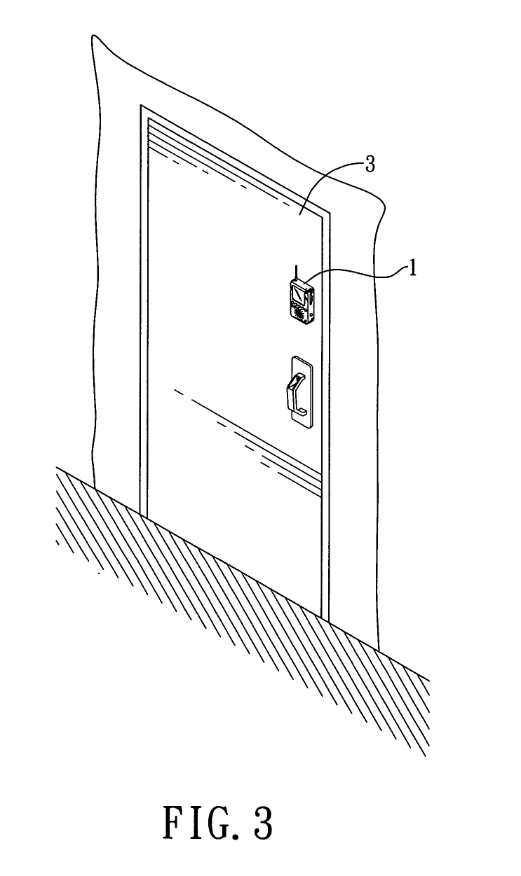

A sensor 2 is used to transmit the sensor signal to the control unit 11 so as to drive the showing device to show the content of the predetermined message. The sensor 2 is an optical switch, a magnetic control switch, or a micro switch.

Whereas the aforementioned description, as shown in FIG. 3, since a front gate or a room gate is the most important entrance of a house and is a requisite daily route, the present invention can be fixed on a proper position on the front gate or the room gate. By using the predetermined record/display button 17, the message can be recorded for a predetermined person to remind or care for the family member. After the message is recorded, the corresponding indicator light 171 will be lighted to remind this predetermined person to take this message. Thus, when a person comes home and sees that the indicator light 171 is lighted up, he will realize that there is a reminding and care message from his family. Accordingly, an interactive emotion exchange effect is accomplished.

By using the setting of the timer 16 the present invention is enable to provide various reminding at a predetermined date and a predetermined time, for example, if the little son came home at four clocks afternoon, then “less Gameboy, more readies” will be broadcasted, or blessing upon his birthday will be shown on his birthday, so as to achieve the purpose of reminding and concern.

The sensor 2 is an optical switch or a magnetic control switch to detect and recognize the getting home person for showing a predetermined voice for him, for example, if the taller person, namely, father is detected “thank you for working hard, dad” is then broadcasted. In the other hard, the switch type sensor 2 can be mounted on the door side through a connection line. If the door is open, the sensor 2 will be triggered to transmit a sensor signal to the control unit 11 to enable the showing device to broadcast the message. The photographic device 13 also provides with a monitoring function. When the door is open, the photographic function will be enabled to provide with a burglarproof purpose. Notes can be taken down through the photographic device 13 to verify that who came back and went out at what time.

In the present invention, a memory card slot 141 is mounted on the main body 1 for receiving a memory card to store data of the recorded/captured image and voice. The data can be transmitted to the computer through the wireless transceiver 18 or the connector 19 to modify, store, and forward the data.

Consequently, according to the configuration of the present invention, an omnibearing image and voice message apparatus is provided. The member of the family is able to pre-record the matter that he wants to account for, the words that he cannot say face to face, or the surprise that he wants to give on a special date, such as birthday. In all of these circumstances, the present invention can be applied to achieve the purposes of reminding, warning, and encouraging one another. Thus, the present invention is an excellent interactive communication medium.

Therefore, as is understood by a person skilled in the art, the present invention achieves the aforementioned purpose according to the above description and satisfies requirements of patent law. The application for a patent is therefore submitted.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What the invention claimed is:

1. An interactive message apparatus comprising:
a control unit for processing and controlling the recording and showing of an image and a voice acted as a signal processing control center;
a voice input device for inputting a voice signal to record the voice connected to the control unit;
a photographic device for capturing the image through a camera lens and processing an image signal;
a plurality of indicator lights for notifying that there is a message; and
a showing device for showing the recorded image and voice message connected to the control unit.

2. The interactive message apparatus of claim 1, wherein a timer is connected to the control unit to broadcast a predetermined voice at a predetermined time.

3. The interactive message apparatus of claim 1, wherein a sensor is connected to the control unit so as to transmit a sensor signal to the control unit and to drive the showing device to broadcast the recorded message.

4. The interactive message apparatus of claim 3, wherein the sensor is a micro switch.

5. The interactive message apparatus of claim 3, wherein the sensor is an optical switch.

6. The interactive message apparatus of claim 1, wherein a plurality of record/display buttons corresponding to the plurality of indicators lights are connected to the control unit for recording the image and voice or taking the message.

7. The interactive message apparatus of claim 1, wherein the record/display device comprises a monitor to show the recorded image, and a speaker to broadcast the voice.

8. The interactive message apparatus of claim 1, wherein a storage device for storing data of the image and the voice is connected to the control unit.

9. The interactive message apparatus of claim 1, wherein a wireless transceiver module for data transmission with a computer or other compliant apparatus is connected to the control unit.

10. The interactive message apparatus of claim 9, wherein the wireless transceiver module is a Radio Frequency Identification Code (RFID).

11. The interactive message apparatus of claim 1, wherein a connector is connected to the control unit.
